(19) United States
(12) Patent Application Publication
(10) Pub. No.: US 2017/0295124 A1
(43) Pub. Date: Oct. 12, 2017

(54) Real Buddies

(71) Applicant: Jasper Nino Embing Golingho, Johnstown, PA (US)

(72) Inventor: Jasper Nino Embing Golingho, Johnstown, PA (US)

(21) Appl. No.: 15/011,324

(22) Filed: Apr. 11, 2016

(51) Int. Cl. H04L 12/58; G06Q 30/02; H04L 29/08

(52) U.S. Cl. CPC H04L 51/32; H04L 67/306; G06Q 30/0261; G06Q 50/01

(57) ABSTRACT

A social networking website that connects people with different exercise interest whether walking, jogging or running. The member will create a profile account wherein they can invite or accept another account holders with the same exercise interest. This provides a convenient way for members to meet other exercise enthusiast to share ideas, meet up, motivate one another and create a health group.

### BACKGROUND OF THE INVENTION

This invention is a social networking website that is classified under utility patent. This website is a useful process to conveniently connect with friends and other users that will encourage one another to meet their health goals in one click. Interested participants will all sign up in the website that connects everyone. The website allows its users to interact by sharing ideas, stories, tips, journey and exercise events and meet ups.

Given the nature of a website, possible challenges are keeping the private information of its user's safety, network outage, keeping the website mobile-friendly. Also, as a user decides to meet up with one another, participants must be aware of the possible risks to their safety.

### BRIEF SUMMARY OF THE INVENTION

Having a friend around you that will encourage you to walk, jog or run is a great motivation to promote exercise adherence. It is a known fact that regular exercise is beneficial to our health. It decreases the risks for developing chronic diseases such as obesity, diabetes mellitus, coronary heart diseases, anxiety and depression. The biggest dilemma is “motivation”. This website will help users find social support. Website members will be able to share their stories, personal journeys, advices/tips to losing weight, healthy recipes, fun exercise routine, exercise meet ups and events. This website will change how we view exercise. It will encourage and motivate users while having fun meeting new friends and achieving their health goal.

### DETAILED DESCRIPTION OF THE INVENTION

A website which enables a user to create a profile account for free. There will be three categories in each profile account. First is walk, second is jog and third is run. Each user can pick one or multiple categories. Each user can invite, accept or decline another account user. Each user can send messages to another account holders where they can set up a place and time on how they can meet up. Users can post pictures, videos and ideas.

The website has a useful tool called the navigational map. The navigational map groups users by city. It allows users to select their current location and find network of users in the same location, whom they can interact and invite for local events and meet ups.

The website will have a “Buy” button. This buy button will enable users to shop for any product, given that they have a bank account set up with their profile. Users can pay using their credit or debit cards. Upon signing up, users have the option to set up or not set up their bank account with their profile account. The bank account is a hidden and secured information, not visible to any other users.

The website allows for paid advertising. Local advertisement will appear selectively on user's page depending on their account preferences and location.

What is claimed is:

1. A website that connects people with different exercise interest whether to walk, jog or run; provide a convenient way for members to meet other exercise enthusiast to share ideas, meet up, motivate one another and create a help group.

2. The method of claim 1, wherein the user of the website can create a profile account for free.

3. The method of claim 2, wherein each profile account consist of three categories such as walk, jog and run.

4. The method of claim 3, wherein the user of the website can pick one or more categories.

5. The method of claim 1, wherein each user of the website can invite, accept or decline another account user.

6. The method of claim 1, wherein each user of the website can send messages to another users where they can set up a place and time on how they can meet up.

7. The method of claim 1, wherein each user of the website can post pictures, videos and ideas.

8. The method of claim 1, wherein the website has a useful tool called the navigational map that groups users by city.

9. The method of claim 8, wherein the navigational map allows users to select their current location and find network of users in the same location, whom they can interact and invite for local events and meet ups.

10. The method of claim 1, wherein the website will have a buy button that enables users to shop for any product, given that they have a bank account set up with their profile.

11. The method of claim 10, wherein each users can pay using their credit or debit cards.

12. The method of claim 10, wherein the bank account is a hidden and secured information, not visible to any other users.

13. The method of claim 1, wherein the website allows for paid advertising.

14. The method of claim 13, wherein local advertisement will appear selectively on user's page depending on their account preferences and location.
